(19) United States
(12) Patent Application Publication
(10) Pub. No.: US 2026/0222796 A1
(43) Pub. Date: Jul. 30, 2026

(54) HANDLING SESSION MANAGEMENT PROCEDURE OUTSIDE OF NETWORK SLICE SUPPORTED AREA OR TIME

(71) Applicant: Samsung Electronics Co., Ltd., Suwon-si (KR)

(72) Inventors: Lalith KUMAR, Bangalore (IN); Ashok Kumar NAYAK, Bangalore (IN); Danish Ehsan HASHMI, Bangalore (IN); Jagadeesh GANDIKOTA, Bangalore (IN); Koustav ROY, Bangalore (IN); Krishnamurthy D R, Bangalore (IN)

(21) Appl. No.: 19/629,617

(22) Filed: Mar. 26, 2026

Related U.S. Application Data
(63) Continuation of application No. PCT/KR2024/014649, filed on Sep. 26, 2024.

(30) Foreign Application Priority Data
Sep. 29, 2023 (IN) 202341065765
Sep. 13, 2024 (IN) 2023 41065765

(51) Int. Cl. H04W 8/22; H04W 76/00

(52) U.S. Cl. CPC H04W 8/22; H04W 76/00

(57) ABSTRACT

The disclosure relates to a fifth generation (5G) or sixth generation (6G) communication system for supporting a higher data transmission rate. A method performed by a user equipment (UE) for handling session management (SM) procedure in a wireless network system is provided. The method includes establishing, by the UE, a protocol data unit (PDU) session with a network apparatus in the wireless network system, determining, by the UE, whether the UE is in an area where a single-network slice selection assistance information (S-NSSAI) associated with the PDU session is not allowed or not supported by the network apparatus, and in case that the UE is in the area where the S-NSSAI of the PDU session is not allowed or not supported by the network apparatus, initiating, by the UE, a PDU session release procedure or initiating a PDU session modification procedure.

### CROSS-REFERENCE TO RELATED APPLICATION(S

This application is a continuation application, claiming priority under 35 U.S.C. § 365(c), of an International application No. PCT/KR2024/014649, filed on September 26, 2024, which is based on and claims the benefit of an Indian Provisional patent application number 202341065765, filed on September 29, 2023, in the Indian Patent Office, and of an Indian Non-Provisional patent application number 202341065765, filed on September 13, 2024, in the Indian Patent Office, the disclosure of each of which is incorporated by reference herein in its entirety.

### BACKGROUND

### 1. Field

The disclosure relates to wireless communication. More particularly, the disclosure relates to a method and system for handling session management procedure outside of network slice supported Area or time.

### 2. Description of Related Art

Fifth generation (5G) mobile communication technologies define broad frequency bands such that high transmission rates and new services are possible, and can be implemented not only in "Sub 6GHz" bands such as 3.5GHz, but also in "Above 6GHz" bands referred to as millimeter-wave (mmWave) including 28GHz and 39GHz. In addition, it has been considered to implement sixth generation (6G) mobile communication technologies (referred to as Beyond 5G systems) in terahertz bands (for example, 95GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive multiple input and multiple output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR user equipment (UE) Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultra-high-performance communication and computing resources.

In the realm of wireless networks, a Packet Data Unit (PDU) serves as a logical connection between User Equipment (UE) and a Data Network (DN). The process of establishing a data path between the UE and the 5G core network is known as PDU Session Establishment. The PDU session is associated with a specific network slice, and the mapping of these PDU sessions is managed by the 5G Session Management (5GSM) framework. The 5GSM framework encompasses the processes of session establishment, session modification, and session release, ensuring efficient data transmission between the UE and a network apparatus.

However, several problems arise when the UE is located in an area that is not supported by the network apparatus, significantly impacting its ability to perform 5GSM processes. If the UE is in such an unsupported area, it will not be able to register or establish a PDU session. Additionally, if the UE is in an area where partial network slice support is available or if network slices are rejected by the network apparatus, the UE's ability to access the network and perform necessary 5GSM procedures can be severely limited.

For instance, when the UE is in an area with a partially allowed Network Slice Selection Assistance Information (NSSAI), it may request multiple Single-Network Slice Selection Assistance Information (S-NSSAIs). However, the network apparatus may allow a subset of the requested S-NSSAIs, restricting the UE to access the network slices that are part of the allowed NSSAI. If S-NSSAIs are rejected, the UE will be unable to establish PDU sessions for the rejected slices, thereby limiting its access to specific services.

The partially allowed NSSAI indicates the S-NSSAI values that the UE could use in the serving Public Land Mobile Network (PLMN) or Standalone Public Network (SNPN) in some areas within the current registration area. Each S-NSSAI in the partially allowed NSSAI is associated with a list of areas where the S-NSSAI is supported. The network slice area of service is defined as the area where the UE can access and receive service from a particular network slice, provided that more than zero resources are allocated to the network slice in the Next Generation Radio Access Network (NG-RAN) cells.

The S-NSSAI location availability information sent to the UE includes, for applicable S-NSSAI, location information indicating the cells of Tracking Areas (TAs) in the Registration Area (RA) where the related S-NSSAI is available or supported. This information can also indicate the cells where the S-NSSAI is not supported. The cell can be identified using a cell identifier (ID) or any other identifier that can identify a given cell or group of cells e.g. Tracking area (TA).

FIG. 1 is a sequence diagram that illustrates the SM procedure in a not supported Area of service or outside of time validity Area according to the related art.

For example, as illustrated in FIG. 1, the UE sends an uplink (UL) non-access stratum (NAS) message (S101), such as a registration request message, including S-NSSAI-1 in the requested NSSAI list. The network function entity responds with a downlink (DL) NAS message (S102), such as a registration accept message, including S-NSSAI-1 in the partially allowed NSSAI list, indicating a supported list of TAs, such as TA-1, this implies TA-2 is not supporting the S-NSSAI-1. The current registration area includes both TA-1 and TA-2. After receiving the registration accept message, the UE moves to TA-2 (S103). However, whether the 5GSM procedure can be performed in TA-2 (S104) is not defined in conventional methods. Similarly, when the UE is outside the network slice area of service or outside the S-NSSAI location availability information or time validity window, the ability to perform 5GSM procedures is also not defined in conventional methods.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a system and method for handling session management procedures outside of the network slice supported area or time.

Another aspect of the disclosure is to perform PDU session release or PDU session modification associated with the UE when the UE is in the TA where the S-NSSAI of the PDU session is not allowed or not supported by the network apparatus.

Another aspect of the disclosure is to allow the PDU session release procedure or PDU session modification procedure for correct operations of the network apparatus when all the aspects are barred for the UE.

Additional aspects will be set forth in part in the description which follows and, in part, will be apparent from the description, or may be learned by practice of the presented embodiments.

In accordance with an aspect of the disclosure, a method performed by a user equipment (UE) for handling session management (SM) procedure in a wireless network system is provided. The method including establishing, by the UE, a protocol data unit (PDU) session with a network apparatus in the wireless network system, determining, by the UE, whether the UE is in an area where a single-network slice selection assistance information (S-NSSAI) associated with the PDU session is not allowed or not supported by the network apparatus, and in case that the UE is in the area where the S-NSSAI of the PDU session is not allowed or not supported by the network apparatus, initiating, by the UE, a PDU session release procedure or initiating a PDU session modification procedure.

In an embodiment, initiating by the UE the PDU session release procedure with the network apparatus to release the PDU session includes transmitting the PDU session release request message to the network apparatus to release the PDU session and receiving the PDU session release procedure message from the network apparatus to release the PDU session. Further, the PDU session modification procedure involves transmitting by the UE a PDU session modification request message to the network apparatus to modify the PDU session. Further, the UE receives the request from the network apparatus for PDU session modification COMMAND message from the network apparatus to modify the PDU session.

In an embodiment, the Area includes a Tracking Area (TA) or a cell wherein determining by the UE whether the UE is in the Area where the S-NSSAI associated with the PDU session is not allowed or is not supported by the network apparatus includes detecting by the UE that the UE is not in the cell or not in the TA where the S-NSSAI is supported based on at least one of the Partially Allowed NSSAI list, network slice area of service location availability information of the S-NSSAI, Partially Rejected NSSAI list and a time validity window of the S-NSSAI stored at the UE.

In accordance with another aspect of the disclosure, a method performed by a network apparatus for handling session management (SM) procedure in a wireless network system is provided. The method including establishing, by the network apparatus, a protocol data unit (PDU) session with a user equipment (UE) in the wireless network system, receiving, by the network apparatus, one of a PDU session release request message or a PDU session modify request message from the UE, in case that the UE is in an area where a single-network slice selection assistance information (S-NSSAI) associated with the PDU session is not allowed or not supported by the network apparatus, and performing, by the network apparatus, one of releasing the PDU session associated with the UE when the PDU session release request message is received from the UE, and transmitting a PDU session release response message to the UE after releasing the PDU session, or modifying the PDU session associated with the UE when the PDU modify release request message is received from the UE, and transmitting a PDU session modify response message to the UE after modifying the PDU session.

In accordance with another aspect of the disclosure, a user equipment (UE) for handling session management (SM) procedure in a wireless network system is provided. The UE includes a transceiver, and memory, including one or more storage media, storing instructions, and one or more processors communicatively coupled to the transceiver and the memory, wherein the instructions, when executed by the one or more processors individually or collectively, cause the UE to establish a protocol data unit (PDU) session with a network apparatus in the wireless network system, determine whether the UE is in an area where a single-network slice selection assistance information (S-NSSAI) associated with the PDU session is not allowed or not supported by the network apparatus, and in case that the UE is in the area where the S-NSSAI of the PDU session is not allowed or not supported by the network apparatus, initiate a PDU session release procedure or initiate a PDU session modification procedure.

In accordance with another aspect of the disclosure, a network apparatus for handling session management (SM) procedure in a wireless network system is provided. The network apparatus includes a transceiver, and memory, including one or more storage media, storing instructions, and one or more processors communicatively coupled to the transceiver and the memory, wherein the instructions, when executed by the one or more processors individually or collectively, cause the network apparatus to establish a protocol data unit (PDU) session with a user equipment (UE) in the wireless network system, receive one of a PDU session release request message or a PDU session modify request message from the UE, in case that the UE is in an area where a single-network slice selection assistance information (S-NSSAI) associated with the PDU session is not allowed or not supported by the network apparatus, and perform one of release the PDU session associated with the UE when the PDU session release request message is received from the UE, and transmit a PDU session release response message to the UE after releasing the PDU session, or modify the PDU session associated with the UE when the PDU modify release request message is received from the UE, and transmit a PDU session modify response message to the UE after modifying the PDU session.

In accordance with another aspect of the disclosure, one or more non-transitory computer-readable storage media storing one or more computer programs including computer-executable instructions that, when executed by one or more processors of a user equipment (UE) individually or collectively, cause the UE to perform operations are provided. The operations include establishing, by the UE, a protocol data unit (PDU) session with a network apparatus in a wireless network system, determining, by the UE, whether the UE is in an area where a single-network slice selection assistance information (S-NSSAI) associated with the PDU session is not allowed or not supported by the network apparatus, and in case that the UE is in the area where the S-NSSAI of the PDU session is not allowed or not supported by the network apparatus, initiating, by the UE, a PDU session release procedure or initiating a PDU session modification procedure.

Embodiments of the disclosure provides methods and apparatus for handling session management procedure outside of the network slice supported area or time. In one embodiment, PDU session release procedure or PDU session modification procedure can be performed when UE is outside of the network slice supported area or time.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a sequence diagram that illustrates the SM procedure in a not supported Area of service or outside of time validity Area according to the related art;

FIG. 2 is a block diagram that illustrates the hardware components associated with the UE according to an embodiment of the disclosure;

FIG. 3 is a sequence diagram that illustrates the procedure of performing the SM procedure in a not supported Area of service or outside of time validity Area according to an embodiment of the disclosure;

FIG. 4 is a sequence diagram that illustrates the SM procedure that is not supported in a not supported Area of service or outside of time validity Area according to an embodiment of the disclosure; and

FIG. 5 is a sequence diagram that illustrates the method for handling the SM procedure in a wireless network system according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Also, the various embodiments described herein are not necessarily mutually exclusive, as some embodiments can be combined with one or more other embodiments to form new embodiments. The term "or" as used herein refers to a non-exclusive "or" unless otherwise indicated.

As is traditional in the field, embodiments are described and illustrated in terms of blocks that carry out a described function or functions. These blocks, which are referred to herein as managers, units, modules, hardware components, or the like, are physically implemented by analog and/or digital circuits such as logic gates, integrated circuits, microprocessors, microcontrollers, memory circuits, passive electronic components, active electronic components, optical components, hardwired circuits, and the like, and optionally be driven by firmware and software. The circuits, for example, be embodied in one or more semiconductor chips or on substrate supports such as printed circuit boards and the like. The circuits constituting a block be implemented by dedicated hardware or by a processor (e.g., one or more programmed microprocessors and associated circuitry) or by a combination of dedicated hardware to perform some functions of the block and a processor to perform other functions of the block. Each block of the embodiments be physically separated into two or more interacting and discrete blocks without departing from the scope of the proposed method. Likewise, the blocks of the embodiments be physically combined into more complex blocks without departing from the scope of the proposed method.

The accompanying drawings are used to help easily understand various technical features, and it is understood that the embodiments presented herein are not limited by the accompanying drawings. As such, the proposed method is construed to extend to any alterations, equivalents, and substitutes in addition to those which are particularly set out in the accompanying drawings. Although the terms first, second, etc. are used herein to describe various elements, these elements are not to be limited by these terms. These terms are generally used to distinguish one element from another.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth^{®} chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

In an aspect, the objects are achieved by providing a method and system for handling Session Management (SM) procedure in a wireless network system. The UE establishes a PDU session between the UE and a network apparatus in the wireless network system, and the UE determines whether the UE is in an area where an S-NSSAI associated with the PDU session is not allowed or not supported by the network apparatus. When the UE is in the area where the S-NSSAI of the PDU session is not allowed or not supported by the network apparatus, the UE allows initiating a PDU session release procedure with the network apparatus to release the PDU session or to initiate a PDU session modification procedure to the network apparatus to modify the PDU session and it bars to initiate/execute any other 5GSM procedure with the network.

In another aspect, the objects are achieved by providing a method and system for handling Session Management (SM) procedure in a wireless network system wherein the network apparatus establishes the PDU session with a UE in the wireless network system. Further, the network apparatus receives one of a PDU session release request message or a PDU session modify request message from the UE when the UE is in the area where the S-NSSAI associated with the PDU session is not allowed or not supported by the network apparatus. Furthermore, the UE performs either of releasing the PDU session associated with the UE or modifying the PDU session associated with the UE when the PDU session release request message is received from the UE or when the PDU modify release request message is received from the UE, respectively. Further, the network apparatus transmits the PDU session release response message i.e. the network initiates PDU session release procedure by sending the PDU session release message to the UE to release the PDU session or PDU session modify response message to the UE i.e. the network entity for e.g. the session management function (SMF) shall perform/execute the network-requested PDU session modification procedure by sending the PDU SESSION MODIFICATION COMMAND message to the UE to modify the PDU session.

In one aspect, the objects are achieved by providing the UE for handling Session Management (SM) procedure in a wireless network system that includes a memory that includes information about a network apparatus associated with the UE, a processor, a PDU session controller coupled to the memory, and the processor configured to establish a PDU session between the UE and a network apparatus in the wireless network system. Further, the PDU session controller determines whether the UE is in an area where an S-NSSAI associated with the PDU session is not allowed or not supported by the network apparatus. When the UE is in the area where the S-NSSAI of the PDU session is not allowed or not supported by the network apparatus, initiate by the UE the PDU session release procedure with the network apparatus to release the PDU session or initiate the PDU session modification procedure to the network apparatus to modify the PDU session.

In another aspect, the objects are achieved by providing a network apparatus for handling Session Management (SM) procedure in a wireless network system that includes a memory comprising information about a network apparatus associated with the UE, a processor, and a PDU session controller coupled to the memory and the processor configured to establish the PDU session with a UE in the wireless network system. Further, the network apparatus receives one of a PDU session release request message or a PDU session modify request message from the UE when the UE is in an area where an S-NSSAI associated with the PDU session is not allowed or not supported by the network apparatus. Based on the request by the UE, the network apparatus performs either of releasing the PDU session associated with the UE when the PDU session release request message is received from the UE and transmits a PDU session release response message to the UE to release the PDU session or modifying the PDU session associated with the UE when the PDU modify release request message is received from the UE and transmits a PDU session modify response message to the UE after modifying the PDU session.

In this embodiment sending the PDU session release response message to the UE implies that the network apparatus initiates PDU session release procedure by sending the PDU session release message to the UE to release the PDU session.

In this embodiment, the network apparatus transmits a PDU session modify response message to the UE which implies that the network apparatus for e.g. the SMF shall perform/execute the network-requested PDU session modification procedure by sending the PDU SESSION MODIFICATION COMMAND message to the UE to modify the PDU session.

In wireless networks, communication between the UE and the network apparatus involves establishing and managing PDU sessions. The PDU sessions are used for data transfer, and are established through specific signaling messages. When the UE requests a PDU session, the network apparatus' Session Management Function (SMF) processes this request. If the network apparatus cannot establish the session due to several reasons like insufficient resources for specific network slice, not supported SSC mode, and others, the SMF will respond with a PDU SESSION ESTABLISHMENT REJECT message.

In wireless networks, the S-NSSAI is used for selecting the appropriate network slice for the particular PDU session. Each S-NSSAI represents a network slice and is used by the network apparatus to ensure that the UE's session is allocated to the correct slice, which provides specific Quality of Service (QoS) and network capabilities. When the UE requests a PDU session with an S-NSSAI that is not supported or allowed in the current area, the network apparatus cannot establish the requested session because it cannot allocate resources in the specified network slice. Further, the UE will not be able to access services that require the specific S-NSSAI, potentially leading to service disruptions or failures in connectivity. The network apparatus may face challenges in managing and allocating resources if the UE frequently requests network slices that are not supported in the current area. This can impact overall network efficiency and resource utilization.

The Evolved Packet Core (EPC) architecture is a fundamental component in the network architecture. The EPC manages the signaling for mobility and session management. One of the key components of the EPC is the Evolved Mobility Management (EMM) sublayer, which is responsible for handling mobility management and session management for the UE. In an embodiment, the term EMM sublayer states are at least one of the below.

1) EMM-NULL

2) EMM-DEREGISTERED

a) EMM-DEREGISTERED.NORMAL-SERVICE

b) EMM-DEREGISTERED.LIMITED-SERVICE

c) EMM-DEREGISTERED.ATTEMPTING-TO-ATTACH

d) EMM-DEREGISTERED.PLMN-SEARCH

e) EMM-DEREGISTERED.NO-IMSI

f) EMM-DEREGISTERED.ATTACH-NEEDED

g) EMM-DEREGISTERED.NO-CELL-AVAILABLE

h) EMM-DEREGISTERED.eCALL-INACTIVE

3) EMM-REGISTERED-INITIATED

4) EMM-REGISTERED

a) EMM-REGISTERED.NORMAL-SERVICE

b) EMM-REGISTERED.ATTEMPTING-TO-UPDATE

c) EMM-REGISTERED.LIMITED-SERVICE

d) EMM-REGISTERED.PLMN-SEARCH

e) EMM-REGISTERED.UPDATE-NEEDED

f) EMM-REGISTERED.NO-CELL-AVAILABLE

g) EMM-REGISTERED.ATTEMPTING-TO-UPDATE-MM

h) EMM-REGISTERED.IMSI-DETACH-INITIATED

5) EMM-DEREGISTERED-INITIATED

6) EMM-TRACKING-AREA-UPDATING-INITIATED

7) EMM-SERVICE-REQUEST-INITIATED

The term 5GMM sublayer state in this embodiment is at least one of the below:

1) 5GMM-NULL

2) 5GMM-DEREGISTERED

a) 5GMM-DEREGISTERED.NORMAL-SERVICE

b) 5GMM-DEREGISTERED.LIMITED-SERVICE

c)5GMM-DEREGISTERED.ATTEMPTING-REGISTRATION

d) 5GMM-DEREGISTERED.PLMN-SEARCH

e) 5GMM-DEREGISTERED.NO-SUPI

f) 5GMM-DEREGISTERED.NO-CELL-AVAILABLE

g) 5GMM-DEREGISTERED.eCALL-INACTIVE

h) 5GMM-DEREGISTERED.INITIAL-REGISTRATION-NEEDED

3) 5GMM-REGISTERED-INITIATED

4) 5GMM-REGISTERED

a) 5GMM-REGISTERED.NORMAL-SERVICE

b) 5GMM-REGISTERED.NON-ALLOWED-SERVICE

c)5GMM-REGISTERED.ATTEMPTING-REGISTRATION-UPDATE

d) 5GMM-REGISTERED.LIMITED-SERVICE

e) 5GMM-REGISTERED.PLMN-SEARCH

f) 5GMM-REGISTERED.NO-CELL-AVAILABLE

g) 5GMM-REGISTERED.UPDATE-NEEDED

5) 5GMM-DEREGISTERED-INITIATED

6) 5GMM-SERVICE-REQUEST-INITIATED

5GMM-IDLE mode: In 5G networks, 5GMM-IDLE mode refers to a state where the UE is registered with the network but is not actively communicating or transmitting data. The UE can be either in 5GMM-IDLE mode over 3rd Generation Partnership Project (3GPP) access or in 5GMM-IDLE mode over non-3GPP access. The UE is in 5GMM-IDLE mode over 3GPP access when the UE is idle within a cellular network (e.g., long term evolution (LTE) or 5G NR) and follows procedures specific to cellular technologies. Whereas 5GMM-IDLE over Non-3GPP Access refers to the UE in idle while connected through non-cellular technologies (e.g., Wi-Fi) but still maintains its connection to the 5G core network, and different procedures may apply for tracking and paging.

5GMM-CONNECTED mode: In this specification, if the term is used standalone, a UE in 5GMM-CONNECTED mode means the UE can be either in 5GMM-CONNECTED mode over 3GPP access or in 5GMM-CONNECTED mode over non-3GPP access.

5GMM-IDLE mode over 3GPP access: A UE is in 5GMM-IDLE mode over 3GPP access when no N1 NAS signalling connection between the UE and Network (i.e. Network function e.g. access and mobility management function (AMF)/SMF/user plane function (UPF)) over 3GPP access exists. The term 5GMM-IDLE mode over 3GPP access used in the document corresponds to the term CM-IDLE state for 3GPP access used in 3GPP TS 23.501 8.

5GMM-CONNECTED mode over 3GPP access: A UE is in 5GMM-CONNECTED mode over 3GPP access when an N1 NAS signalling connection between the UE and Network (i.e. Network function e.g. AMF/SMF/UPF) over 3GPP access exists. The term 5GMM-CONNECTED mode over 3GPP access used in the document corresponds to the term CM-CONNECTED state for 3GPP access used in 3GPP TS 23.5018.

The Service Request procedure in 5G is used when a device wants to establish a connection to the AMF. There are two possible scenarios in which this can happen: Network Triggered and UE Triggered Request. In an embodiment all below messages either from the network apparatus or the UE will be considered as 5G SM Procedures:

### Network Initiated:

PDU session authentication and authorization procedure

Service-level authentication and authorization procedure

Network-requested PDU session modification procedure

Network-requested PDU session release procedure

UE Initiated:

### UE-requested PDU session establishment procedure

UE-requested PDU session modification procedure

UE-requested PDU session release procedure

### Miscellaneous:

5GSM status procedure

Exchange of extended protocol configuration options

Remote UE report procedure

Partially Allowed NSSAI: Indicates the S-NSSAIs values the UE could use in the Serving PLMN or SNPN in some of the TAs in the current Registration Area. Each S-NSSAI in the Partially Allowed NSSAI is associated with a list of Areas where the S-NSSAI is supported.

Network Slice Area of Service: The Area where a UE can access and get service of a particular network slice as more than zero resources are allocated to the network slice in the NG-RAN cells.

S-NSSAI location availability information: The S-NSSAI location availability information sent to the UE includes, for each applicable S-NSSAI (optionally of the Configured NSSAI), Location information indicating the cells of TAs in the RA where the related S-NSSAI is available (or supported) if the S-NSSAI is not available (or not supported) in all the cells of the TA. This information can also include the cells where the related/respective S-NSSAI is not supported. The cell can be identified using a cell ID or any other identifier which can identify a given cell or group of cells.

Partly rejected S-NSSAI: AMF or any other network apparatus (i.e. Network function e.g. AMF/SMF/UPF) function) provides information related to the supported or not supported TA(s) regarding a rejected S-NSSAI in the RA to UE in the registration procedure and UE configuration update procedure or any other NAS procedure. The UE shall be able to request a rejected S-NSSAI, by initiating a registration update procedure, in a supported TA based on the supported/not supported TA information associated with this S-NSSAI. The current concept of allowed NSSAI and uniform support of it in UE's RA is not impacted by this feature based on indication of where in RA certain rejected S-NSSAIs are supported/not supported. In this approach, the Allowed NSSAI is still uniformly supported in the RA.

Time Validity Window/ Temporarily available network slices: A network slice may be available for all UEs or a limited number of UEs only for a limited time that is known at the network apparatus in advance e.g. by OAM or subscription. The limited time duration may be due to, for example, the fact that network slice is only temporarily or periodically active in the deployment (e.g. for a limited time to serve an event or a UE may be only authorized to access the network slice for a limited time known in advance), or the network slice is being decommissioned at a known future time. This feature is enabled by S-NSSAI validity time that the network and the UE can handle to reduce the signalling load associated to the transitions in RM and SM states for the network slice.

Partially Allowed NSSAI: Indicating the S-NSSAIs values the UE could use in the serving PLMN or SNPN in some of the TAs in the current registration Area. Each S-NSSAI in the partially allowed NSSAI is associated with a list of TAs where the S-NSSAI is supported. When received, an S-NSSAI rejected partially in the RA is stored in the UE while RM-REGISTERED until the UE moves out of the current Registration Area or until the S-NSSAI is deleted.

A network slice may be supported in one or more TAs in a PLMN/SNPN. The Partial Network Slice support in a Registration Area for a UE includes configuring the UE with a Partially Allowed NSSAI and/or S-NSSAI(s) rejected partially in the RA. When creating a registration Area for the UEs registering over the 3GPP access and supporting the partial network slice support in a registration Area, the AMF may consider the trade-off between signalling for paging in TAs where the S-NSSAI is not supported versus the signalling for mobility registration updates to register with the S-NSSAI in the TA(s) where the S-NSSAI is supported, so that the AMF may create a registration Area including the TA(s) where a requested S-NSSAI is not supported. For such S-NSSAI:

▶ If requested by the UE from a TA where the S-NSSAI is not supported,

▶ then the S-NSSAI is included either in the Partially Allowed NSSAI or the AMF rejects the S-NSSAI partially in the RA; or

▶ if the S-NSSAI is subject to network slice admission control (NSAC) for maximum number of UEs, then the AMF should send this S-NSSAI as rejected partially in the RA.

▶ If requested by the UE from a TA where the S-NSSAI is supported,

▶ the S-NSSAI is included in the Partially Allowed NSSAI; or

▶if the S-NSSAI is subjected to NSAC for maximum number of UEs, then the AMF restricts the RA so that the S-NSSAI is supported in all the TAs of the RA and includes the S-NSSAI in the Allowed NSSAI.

Whether the AMF for supporting UEs uses the partially allowed NSSAI or rejects the S-NSSAIs partially in the RA is as per the S-NSSAI decision which is based on AMF local policy. When supported and allowed by local policy, the partially allowed NSSAI and S-NSSAIs rejected partially in the RA may be applied simultaneously for one UE and for different S-NSSAIs.

While the S-NSSAIs of the Allowed NSSAI are supported in all the TAs of the registration Area, the S-NSSAIs of the partially allowed NSSAI are supported only in the TAs corresponding to the list of TAs (which are subset of the list of Tracking Area Identities (TAI)s forming the registration Area) associated with the S-NSSAI. When the UE supports partial network slice support in a registration Area, the AMF may create a registration Area for the UE considering the support of the S-NSSAIs of the requested NSSAI in the current TA and in the neighbouring TAs and provides to the UE in the registration accept message or in the UE configuration update command message the partially allowed NSSAI or the S-NSSAIs rejected partially in the RA as follows:

▶ If one or more of the requested S-NSSAI(s) are supported in a subset of the TAs of the (potential) Registration Area, the AMF may include such S-NSSAI(s) in the Partially Allowed NSSAI and corresponding mapping information of the S-NSSAI(s) of the Partially Allowed NSSAI to the HPLMN S-NSSAI(s). For each S-NSSAI of the Partially Allowed NSSAI the AMF provides a list of TAs where the S-NSSAI is supported. The UE is considered registered with the S-NSSAI in the whole Registration Area. The AMF also provides the Partially Allowed NSSAI (without indication of the TA list where the partially allowed S-NSSAIs are supported) to the NG-RAN together with the UE's context.

▶ Alternatively, the AMF may reject the S-NSSAI(s) with reject cause indicating "partially in the RA". For each S-NSSAI of the S-NSSAIs rejected partially in the RA the AMF provides a list of TAs for which the S-NSSAI is supported or not supported.

▶ When the UE stores Partially Allowed NSSAI the following applies:

▶ The UE is considered registered with an S-NSSAI of the Partially Allowed NSSAI in the whole Registration Area. The UE does not trigger registration when moving between the TAs of support and non-support for the S-NSSAI within the RA.

▶ The UE is allowed to initiate PDU Session establishment for the S-NSSAI only when the UE is in a TA where the S-NSSAI is supported.

▶ When the UE has already established a PDU Session with an S-NSSAI part of the Partially Allowed NSSAI, the UE is allowed to activate the User Plane Resources of the PDU Session only when the UE is in a TA part of the list of TAs associated with each S-NSSAI.

▶ When the User Plane Resources are activated for a PDU Session to an S-NSSAI part of the Partially Allowed NSSAI and the UE moves to a TA which is not part of the list of TAs associated with the S-NSSAI, the User Plane Resources for the PDU Session shall be deactivated, but the PDU Session context in UE and SMF is not released. The User Plane Resources for the PDU Session shall not be activated as long as the UE is located in a TA which is not part of the list of TAs associated with the S-NSSAI of the Partially Allowed NSSAI.

When the UE stores an S-NSSAI rejected partially in the RA with the associated list of TAs, the UE is allowed to initiate a Mobility Registration Update procedure to request registration with the S-NSSAI only when the UE is in a TA supporting this S-NSSAI.

In an embodiment, the network support for a Network Slice is defined on a per Tracking Area granularity. It may be beneficial to deploy some Network Slices such that the Network Slice has a limited geographical availability that does not match existing Tracking Area boundaries. The operator can, in this case, decide to change the topology of the Tracking Areas so they match the boundaries of the Network Slice, or the operator may configure resources for the Network Slices in the cells of TAs where the Network Slices are to be available. In the areas of the TAs where the network slice is defined to be not available, the cells are configured with zero resources. The AMF receives from the OAM the information on the availability of a network slice when the granularity is smaller than TA, i.e., if the network slice area of service (NS-AoS) includes TAs where the network slice is not available in some cells of the TA. In order to optimize the end-to-end behavior, the AMF can, based on NS-AoS information received from OAM, configure supporting UEs with S-NSSAI location availability information, and the 5GC network may need to monitor the S-NSSAI usage and enforce the NS-AoS, e.g., if the UE does not support the S-NSSAI location availability information.

In an embodiment, the S-NSSAI location availability information defines additional restrictions to the usage of an S-NSSAI in TAs where the Network Slice availability does not match the TA boundaries. The AMF is configured per S-NSSAI whether to send the S-NSSAI location availability information to supporting UEs. The S-NSSAI location availability information sent to the UE includes, for each applicable S-NSSAI of the Configured NSSAI, location information indicating the cells of TAs in the RA where the related S-NSSAI is available if the S-NSSAI is not available in all the cells of the TA. When the UE has indicated that the UE supports S-NSSAI location availability information in the 5GMM Core Network Capability (see clause 544a), the AMF may, based on OAM configuration, configure the UE with S-NSSAI location availability information for one or more S-NSSAIs when the AMF allocates an RA where the Network Slice availability does not match whole TAs by including the S-NSSAI location availability information in the Registration Accept message or the UE Configuration Command message.

The UE that receives S-NSSAI location availability information applies the information as follows:

▶If the S-NSSAI is rejected in the RA or rejected partially in the RA or rejected with a cause code that allows attempting to register the S-NSSAI again, the UE can request the S-NSSAI only if the S-NSSAI location availability information indicates that the S-NSSAI is available at the cell where the UE is camping.

▶ If the S-NSSAI is in the Partially Allowed NSSAI, the UE shall not activate User Plane for any already established PDU Session with that S-NSSAI if the UE is in a cell within the RA but outside the Location information of the S-NSSAI.

▶ If the S-NSSAI is in the Partially Allowed NSSAI, and the UE in CM-IDLE mode is moved to a cell outside the Location information of the S-NSSAI, and the UE has an established PDU Session with that S-NSSAI, the PDU Session is kept.

In an embodiment OAM may configure RRM policies for S-NSSAIs on a per cell basis i.e. cells outside the Network Slice Area of Service while in a TA supporting the S-NSSAI are allocated with no RRM resources for the S-NSSAI. The network may enforce the NS-AoS for an S-NSSAI as follows:

▶ The network monitors the validity of the S-NSSAI for UE in CM-CONNECTED state, i.e. as per the location.

▶If the non-supporting UE makes a PDU Session establishment request with an S-NSSAI that is not valid as per the S-NSSAI location availability information, the AMF may reject the NAS Transport message with a back-off timer using S-NSSAI based congestion control.

▶If the AMF determines that the UE in CM-CONNECTED has moved outside the NS-AoS, the AMF performs the following logic:

a) If the non-supporting UE has other S-NSSAI(s) in the Allowed NSSAI, then the AMF may update updates the UE with a UE Configuration Update by removing the S-NSSAI from the Allowed NSSAI (which causes the UE to locally release the PDU Sessions) and removing the S-NSSAI from the Configured NSSAI, and then the AMF requests the SMF to locally release in the network any PDU Sessions with that.

b) If the non-supporting UE does not have any other S-NSSAI in the Allowed NSSAI, then the AMF may update updates the UE with a UE Configuration Update by removing the S-NSSAI from the Allowed NSSAI (which causes the UE to locally release the PDU Sessions) and removing the S-NSSAI from the Configured NSSAI, and adding a default S-NSSAI to the Allowed NSSAI, and then the AMF requests the SMF to locally release in the network any PDU Sessions with the removed S-NSSAI

c) For a non-supporting UE that does not have any other S-NSSAI in the Allowed NSSAI nor in the Configured NSSAI, then does the AMF indicate to the SMF to release the PDU Session.

▶ When the AMF determines that the S-NSSAI becomes valid e.g. the UE has moved into the NS-AoS, the AMF updates the UE with a UCU e.g. including the S-NSSAI in the Configured NSSAI.

In An embodiment, a network slice may be available for all UEs or a limited number of UEs only for a limited time that is known at the network apparatus in advance, e.g., by OAM or subscription. The limited time duration may be due to, for example, the fact that the network slice is only temporarily or periodically active in the deployment (e.g., for a limited time to serve an event or a UE may be only authorized to access the network slice for a limited time known in advance) or the network slice is being decommissioned at a known future time. This feature is enabled by S-NSSAI validity time that the network apparatus and the UE can handle to reduce the signaling load associated with the transitions in Resource Management (RM) and Session Management (SM) states for the network slice.

In an embodiment, the UE may indicate its support for temporarily available network slices in the UE MM Core Network Capability in the Registration Request. The AMF, based on OAM configuration or information received from the UDM or NSSF, may indicate to a supporting UE the validity time for one or more S-NSSAIs in the Configured NSSAI in the Registration Accept message or via the UE Configuration Update procedure. In a roaming case, the AMF may include the validity time for an S-NSSAI in the Configured NSSAI either because of limited availability of the VPLMN S-NSSAI or the mapped S-NSSAI of the HPLMN.

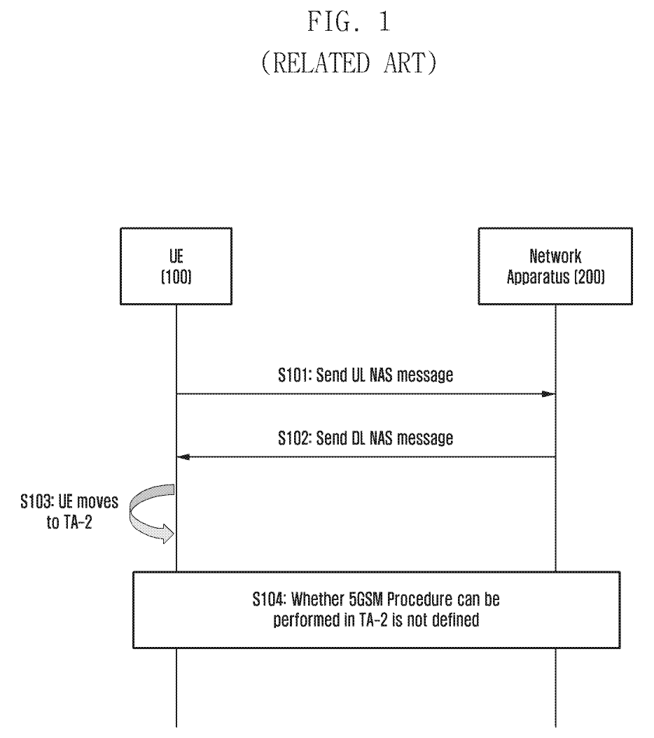

FIG. 1 is a sequence diagram that illustrates the SM (also called as 5GSM procedure) procedure in non-supported TA or not supported Area of service or outside of time validity Area according to the related art.

Referring to FIG. 1, the UE sends an UL NAS message, e.g., a registration request message, including S-NSSAI-1 in the requested NSSAI list. The network function entity sends a DL NAS message, e.g., a registration accept message, including S-NSSAI-1 in the partially allowed NSSAI list, indicating a supported list of TAs as TA-1, and the current registration Area includes TA-1 and TA-2. This implies that TA-2 is not supported/not allowed area for the S-NSSAI-1. The UE moves to TA-2 after receiving the registration accept message from the network function entity. Whether the 5G SM procedure can be performed or not in TA-2 is not defined in conventional methods. Similarly, when the UE is outside of the network slice Area of service or outside of S-NSSAI location availability information or time validity window, whether the 5GSM procedure can be performed or not is not defined in the conventional methods.

In contrast to the conventional methods, the proposed solution provides a method for handling the SM procedures wherein the UE or the network apparatus may perform the 5GSM procedure when the UE is outside the TA or the cell, outside the network slice area of service, or outside of S-NSSAI location availability information or time validity window. This method ensures that the UE can maintain seamless connectivity and service continuity even when it moves to an area that is not traditionally supported by the network. By defining specific conditions and mechanisms under which the 5GSM procedure can be executed outside the predefined areas, the proposed solution enhances the flexibility and robustness of the network.

The proposed solution introduces a dynamic management system that can adapt to varying network conditions and user mobility patterns. For instance, the network function entity can dynamically update the allowed NSSAI list based on real-time network performance and user demand, thereby optimizing resource allocation and improving user experience. Additionally, the UE can be equipped with algorithms to predict its movement and proactively request updates to its NSSAI list, ensuring it remains within supported areas as much as possible. This proactive solution not only reduces the likelihood of service interruptions but also enhances the overall efficiency of the network.

Furthermore, the proposed solution can be integrated with advanced network technologies such as machine learning and artificial intelligence to further enhance its capabilities. For example, machine learning algorithms can analyze historical data to predict areas where users are likely to move and pre-emptively adjust the network configuration to support those areas. Artificial intelligence can be used to optimize the decision-making process for updating NSSAI lists and managing network resources, ensuring that the network can adapt to changing conditions in real-time. By leveraging these advanced technologies, the proposed solution can provide a more resilient and adaptive network that meets the evolving needs of users in a 5G environment.

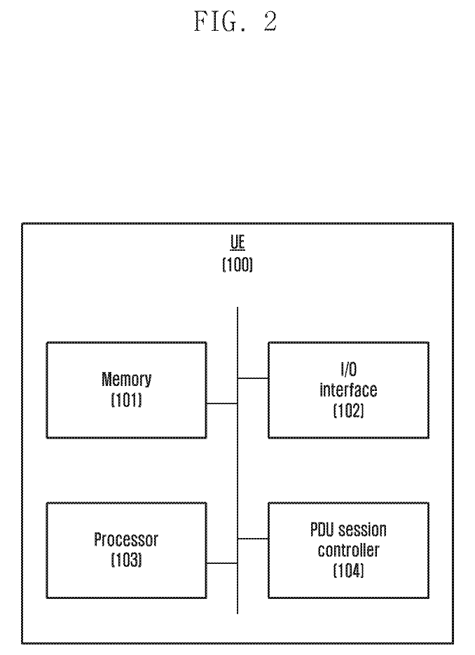

Referring now to the drawings and more particularly to FIGS. 2 to 5, where similar reference characters denote corresponding features consistently throughout the figure, these are shown preferred embodiments.

FIG. 2 is a block diagram that illustrates the hardware components associated with the UE (100) according to an embodiment of the disclosure.

The UE (100) can encompass a diverse range of devices including but not limited to laptops, palmtops, desktops, mobile phones, smartphones, Personal Digital Assistants (PDAs), tablets, wearable devices, Internet of Things (IoT) devices, virtual reality devices, foldable devices, flexible devices, display devices, and immersive systems. In an embodiment, the UE (100) includes a memory (101), a processor (103), an Input/Output (I/O) interface (102), and a PDU session controller (104).

The memory (101) stores instructions to be executed by the processor (103). The memory (101) can include non-volatile storage elements. Examples of such non-volatile storage elements may include magnetic hard disks, optical disks, floppy disks, flash memories, or forms of electrically programmable read only memories (EPROMs) or electrically erasable and programmable ROMs (EEPROM). In addition, the memory (101) may in some examples be considered a non-transitory storage medium. The term non-transitory may indicate that the storage medium is not embodied in a carrier wave or a propagated signal. However, the term non-transitory should not be interpreted that the memory (101) is non-movable. In some examples, the memory (101) stores larger amounts of information. In certain examples, a non-transitory storage medium may store data that can over time change (e.g., in Random Access Memory (RAM) or cache). The memory (101) stores the AI/machine learning (ML) capability of the UE (100), training data of the AI/ML models, and the values of the Key Performance Indicators (KPIs). Further, it stores capabilities of the UE (100) and the information regarding the occurrence of the critical events.

The processor (103) may include one or a plurality of processors. The one or the plurality of processors may be a general-purpose processor such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (103) may include multiple cores and is configured to execute the instructions stored in the memory (101). The processor (103) fetches the AI/ML capability of the UE (100), information regarding the KPIs, and the occurrence of the UE events. Further, the processor (103) retrieves instructions and executes them.

The I/O interface (102) transmits the information between the memory (101) and external peripheral devices. The peripheral devices are the input-output devices associated with a network apparatus (200). The I/O interface (102) receives several pieces of information from a plurality of UEs, network devices, servers, and the like. The I/O interface (102) ensures that the operating speed of the processor is synchronized with respect to the input and output devices. The I/O interface establishes a connection between different peripheral devices like system performance monitor, AI/ML classification model, memory, and others to perform the AI/ML model management for any scenario-specific action like deactivate or switch or fallback or any other functions of the AI/ML model to enhance the user experience.

In an embodiment, the PDU session controller (104) of the UE (100) communicates with the processor (103), I/O interface (102), and memory (101) for dynamically varying the AI/ML capacity of the UE (100) for optimal user experience. The PDU session controller (104) handles the establishment, modification, and release of PDU sessions, which are used for data transmission between the UE (100) and the network apparatus (200). The PDU session controller (104) maintains the session context information, which includes details about the session Quality of Service (QoS) parameters and data routing. Further, the PDU session controller (104) interfaces with other network functions like the User Plane Function (UPF), Access and Mobility Management Function (AMF), and the Application Function (AF) to facilitate and manage sessions and ensures that the data transmission adheres to the required QoS parameters, providing the necessary quality and prioritization for different types of traffic.

In an embodiment, the PDU session controller (104) receives a connection or a new session request from the UE (100) and processes this request by coordinating with other network elements like the Access and Mobility Management Function (AMF) and User Plane Function (UPF). The PDU session controller (104) sets up the required data paths and configures the necessary parameters. If there are changes in the session requirements (e.g., changes in QoS, service type, or session parameters), the PDU session controller (104) updates the session context and adjusts the session parameters accordingly. Further, when the session is no longer needed or is being terminated, the PDU session controller (104) coordinates with the UPF and other involved functions to release resources and clean up session contexts.

The PDU session controller (104) establishes the PDU session between the UE (100) and the network apparatus (200) in the wireless system. Further, the PDU session controller (104) determines whether the UE (100) is in an area where the S-NSSAI associated with the PDU session is not allowed or not supported by the network apparatus (200). When the UE (100) is in an area where the S-NSSAI of the PDU session is not allowed or not supported by the network apparatus (200), the UE (100) initiates the PDU session release procedure with the network apparatus (200) to release the PDU session, or the UE (100) initiates the PDU session modification procedure to the network apparatus (200) to modify the PDU session.

In yet another embodiment, the network apparatus (200) is at least one of the SMF or the AMF network functions in the core network.

In scenarios where the UE (100) needs to release a PDU session, it initiates the PDU session release procedure by transmitting a PDU session release request message to the network apparatus (200). Subsequently, the UE (100) receives a PDU session release response message from the network apparatus (200) confirming the release of the session. This process ensures that network resources are efficiently managed and reallocated as necessary, preventing resource wastage and maintaining network performance.

Conversely, if the UE (100) needs to modify an existing PDU session, it initiates the PDU session modification procedure by transmitting a PDU session modification request message to the network apparatus (200). Upon successful acceptance of the modification request, the UE (100) receives a PDU session modification response message from the network apparatus (200). This modification process allows the UE (100) to adapt to changing network conditions or user requirements, ensuring that the QoS and other session parameters remain optimal for the current context.

The determination of whether the UE (100) is in an area where the S-NSSAI associated with the PDU session is not allowed or supported involves detecting whether the UE (100) is outside of a network slice area of service, outside of location availability information of the S-NSSAI, or outside of a time validity window of the S-NSSAI. This detection mechanism ensures that the UE (100) operates within the constraints of the network's capabilities and policies, thereby maintaining compliance with network regulations and optimizing the user experience. The UE detects this based on at least one of the Partially Allowed NSSAI list, network slice area of service, location availability information of the S-NSSAI, Partially Rejected NSSAI list (i.e. from Partly rejected S-NSSAI) and a time validity window of the S-NSSAI stored at the UE.

The PDU session controller (104) is an inventive hardware component that is incorporated into the UE (100) through processing circuitry comprising logic gates, integrated circuits, microprocessors, microcontrollers, memory circuits, passive and active electronic components, optical components, hardwired circuits, or similar technologies. These circuits can be manifested in one or more semiconductor chips or on substrate supports such as printed circuit boards.

At least one of the plurality of components of the PDU session controller (104) may be implemented through an AI/ML model. A function associated with the AI model may be performed through the memory (101) and the processor (103). The one or a plurality of processors controls the processing of the input data in accordance with a predefined operating rule or the AI/ML model stored in the non-volatile memory and the volatile memory. The predefined operating rule or artificial intelligence model is provided through training or learning.

Here, being provided through learning means that by applying a learning process to a plurality of learning data, a predefined operating rule or AI/ML model of a desired characteristic is made. The learning may be performed in a device itself in which AI/ML according to an embodiment is performed and/or may be implemented through a separate server/system.

The AI/ML model may include a plurality of neural network layers. Each layer has a plurality of weight values and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning process is a method for training a predetermined target device (for example, a robot) using a plurality of learning data to cause, allow, or control the target device to make a determination or prediction. Examples of learning processes include, but are not limited to, supervised learning, unsupervised learning, semi-supervised learning, or reinforcement learning.

Whilst FIG. 2 depicts the hardware components of the UE (100), it should be noted that alternative embodiments are not confined to these elements. The UE (100) may comprise a greater or lesser number of hardware components in other embodiments. Additionally, the labels or names assigned to these elements are purely for illustrative purposes and do not restrict the scope of the disclosure. Furthermore, it is possible for one or more components to be merged together to perform the same or a substantially similar function.

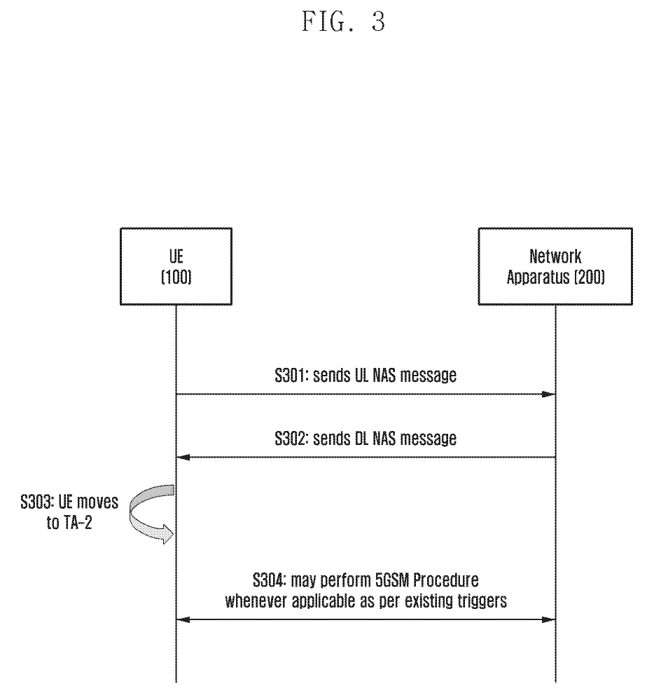

FIG. 3 is a sequence diagram that illustrates the scenario of performing SM procedure in not supported Area of service or outside of time validity Area, according to an embodiment of the disclosure.

The FIG. 3 depicts a scenario where the network apparatus (200) or the UE (100) may perform the 5GSM procedure whenever applicable as per the existing triggers even when the UE (100) is in not supported Area, outside of S-NSSAI location availability information or Time validity window.

At operation S301, the UE (100) sends an Up Link (UL) Non-Access Stratum (NAS) message to the network apparatus (200). The NAS messages carry requests and responses related to the establishment, modification, or release of PDU sessions. Further, the NAS messages include procedures for managing the mobility of the UE (100), such as TA updates, handovers, and location updates. The UL NAS message is sent by the UE (100) to the network apparatus (200) when it initially connects or re-connects, to establish a connection and request network services. The Registration request message is one of the UL NAS messages sent by the UE (100) to the network apparatus (200), wherein the Registration request message includes the S-NSSAI-1 in requested NSSAI list.

Further, in response to the UL NAS message, the network apparatus (200) transmits Down Link NAS message (DL NAS) as depicted in the operation S302. The DL NAS message comprises registration accept that includes partially allowed NSSAI list indicating supported list of the Areas and current registration Area. For example, for the registration request message that includes S-NSSAI-1 in requested NSSAI list, the network apparatus transmits a registration accept message which includes S-NSSAI-1 in partially allowed NSSAI list indicating supported list of TAs as TAI-1 and the current Registration Area includes TAI-1 and TA-2.

At operation S303, the UE (100) moves to TAI-2 after receiving the registration accept message from the network apparatus. Further, the network apparatus (200) (e.g. AMF) or UE (100) may perform 5GSM procedure whenever applicable as per existing triggers (S304) such as registration request, session release request, session modification request and others. Similarly, when the UE (100) is outside of network slice area of service or outside of S-NSSAI location availability information or time validity window, the network apparatus (200) or UE (100) may perform 5GSM procedure whenever applicable as per existing triggers.

In such scenarios, the network apparatus (200) is designed to handle the UE's (100) requests efficiently, ensuring seamless connectivity and service continuity. The network apparatus (200) can dynamically adjust the supported NSSAI lists and registration areas based on the UE's (100) location and time validity information. This flexibility allows the network to maintain optimal performance and service quality, even when the UE (100) moves across different areas or time zones. The ability to perform 5GSM procedures under these conditions enhances the overall user experience by providing reliable and uninterrupted network services.

Moreover, the embodiments disclosed herein emphasize the importance of maintaining robust communication protocols between the UE (100) and the network apparatus (200). By leveraging the UL and DL NAS messages, the network can effectively manage the UE's (100) mobility and session requirements. This approach ensures that the UE (100) remains connected and can access the necessary network resources, regardless of its location or time constraints. The described mechanisms highlight the advanced capabilities of modern 5G networks in supporting diverse and dynamic user scenarios.

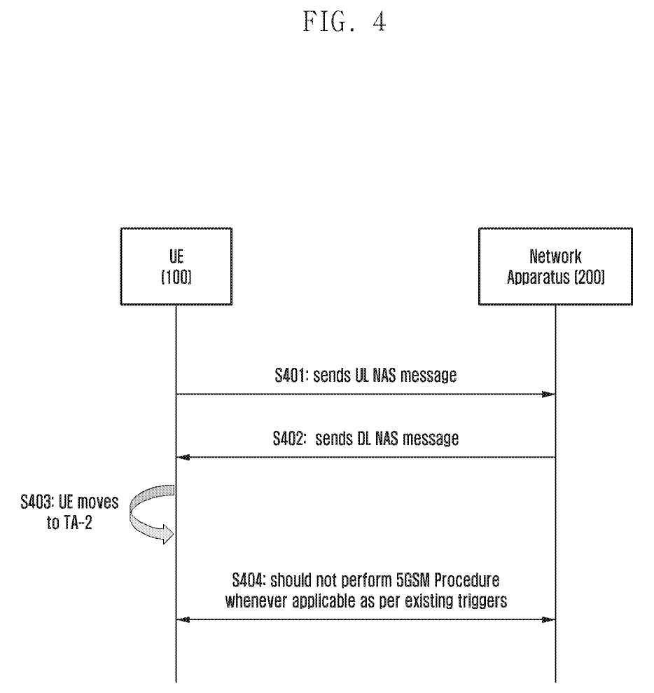

FIG. 4 is a sequence diagram that illustrates the SM procedure that is not supported in not supported Area of service or outside of time validity Area, according to an embodiment of the disclosure.

When the UE (100) is in not supported Area or outside of time validity Area, the network apparatus (200) or the UE (100) should not perform 5GSM procedure. Further, the UE (100) or the network apparatus (200) may retain the 5GSM procedure while the UE (100) is in not supported Area and upon meeting the conditions of the existing trigger, the UE (100) or the network apparatus (200) may perform the 5GSM procedure, once the UE (100) returns to the supported Area.

At operation S401, the UE (100) transmits a UL NAS message to the network apparatus (200). The UL NAS message includes the registration request message to the network apparatus (200) that includes the S-NSSAI in the requested NSSAI list. For example, the UL NAS message may include S-NSSAI-1 in requested NSSAI list. Further, the network apparatus (200) transmits the DL NAS message like registration accept message that includes the S-NSSAI-1 in partially allowed NSSAI list that indicates the supported lists of TAs.

At S402, the network apparatus transmits the DL NAS message to the UE (100) wherein the DL NAS message includes the registration accept message including the S-NSSAI in the partially allowed NSSAI list indicating the supported list of the Areas and current registration Area. Considering an example, for the UL NAS message that includes S-NSSAI-1in requested NSSAI list, the DL NAS message includes the registration accept message including the S-NSSAI-1 in partially allowed NSSAI list indicating the supported list of TAs as TAI-1 and the current registration Area includes TAI-1 and TAI-2.

Further, when the UE (100) moves to TAI-2 (S403), which is a not supported area, the UE (100) or the network apparatus (200) does not perform the 5GSM procedure (S404). Furthermore, if the UE (100) or the network apparatus (200) retains the 5GSM procedure while the UE (100) is in the not supported Area, the UE (100) or the network apparatus (200) may perform the 5GSM procedure when the UE (100) returns to the supported area and upon satisfying any of the existing trigger to send 5GSM procedure is satisfied. For the UE (100) which is in the TAI-2, which is the not supported Area, the UE (100) or the network apparatus (200) does not perform the 5GSM procedure (S404) and may perform the 5GSM procedure once the UE (100) returns to the TAI-1 and any of the existing trigger conditions are satisfied. Further, the UE (100) or the network apparatus (200) may perform the 5GSM procedure when the UE (100) returns to supported Network Slice Area of Service or inside of S-NSSAI location availability information or Time validity window.

In scenarios where the UE (100) transitions between supported and non-supported areas frequently, the network apparatus (200) manages the state of the 5GSM procedures. This ensures that unnecessary signaling and processing are minimized, thereby conserving network resources and maintaining optimal performance. For instance, if the UE (100) temporarily enters a non-supported area but is expected to return to a supported area shortly, the network apparatus (200) may opt to retain the 5GSM procedure in a suspended state rather than terminating it entirely. This approach can reduce the overhead associated with re-establishing the 5GSM procedure once the UE (100) re-enters the supported area.

Moreover, the network apparatus (200) may employ predictive algorithms to anticipate the movement patterns of the UE (100) based on historical data and current location information. By doing so, the network can proactively manage the 5GSM procedures, ensuring seamless transitions between supported and non-supported areas. This predictive capability can be particularly beneficial in scenarios involving high mobility, such as vehicular communication systems, where the UE (100) frequently moves across different TAs. By leveraging such advanced network management techniques, the overall user experience can be significantly enhanced, providing reliable connectivity even in dynamic environments.

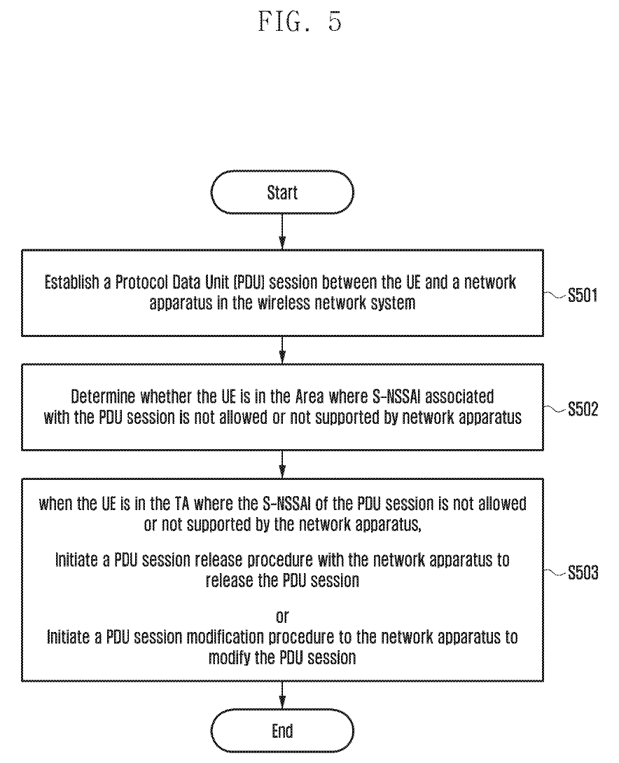

FIG. 5 is a sequence diagram that illustrates the method for handling the SM procedure in a wireless network system according to an embodiment of the disclosure.

The UE (100) establishes a PDU session between the UE (100) and the network apparatus (200) in the wireless network system, as shown in operation S501. This initial operation involves the UE (100) sending a PDU session establishment request to the network apparatus (200), which in turn processes the request and establishes the session, enabling data communication between the UE and the network. This session is used for maintaining a seamless and efficient data flow within the wireless network system.

Further, in operation S502, the UE (100) determines whether it is in an area where a Single Network Slice Selection Assistance Information (S-NSSAI) associated with the PDU session is not allowed or not supported by the network apparatus (200). This determination is used for ensuring that the UE operates within the network's constraints and adheres to the policies defined by the network operator. When the UE (100) is in an area where the S-NSSAI of the PDU session is not allowed or not supported by the network apparatus (200), the UE (100) initiates either the PDU session release procedure or the PDU session modification procedure with the network apparatus (200) to release or modify the PDU session, respectively, as depicted in operation S503. This operation ensures that the UE can adapt to the network's capabilities and restrictions dynamically. The UE initiates the PDU session release procedure or PDU session modification procedure when at least one of the existing triggers occur on the UE side.

The UE initiates UE-requested/initiated PDU session modification procedure is:

a) to enable the UE to request modification of a PDU session;

b) to indicate a change of 3GPP PS data off UE status for a PDU session;

c) to revoke the previously indicated support for reflective QoS;

d) to request specific QoS handling and segregation of service data flows;

e) to indicate to the network the relevant 5GSM parameters and capabilities (e.g. the UE's 5GSM capabilities, whether the UE supports more than 16 packet filters, the maximum data rate per UE for user-plane integrity protection supported by the UE for uplink, the maximum data rate per UE for user-plane integrity protection supported by the UE for downlink and whether the UE requests the PDU session to be an always-on PDU session in the 5G system (5GS)) for a packet data network (PDN) connection established when in S1 mode, after an inter-system change from S1 mode to N1 mode, if the UE is a UE operating in single-registration mode in a network supporting N26 interface and the UE has not previously successfully performed the UE-requested PDU session modification to indicate to the network the relevant 5GSM parameters and capabilities;

f) to delete one or more mapped evolved packet system (EPS) bearer contexts;

g) to convey a port management information container;

h) to re-negotiate header compression configuration associated to a PDU session using control plane C IoT 5GS optimization; or

i) to enable the UE to request to join or leave one or more multicast MBS sessions associated with a PDU session.

j) to send the user equipment route selection policy (URSP) rule enforcement report to the network associated to:

1) an established PDU session; or

2) a PDN connection, after an inter-system change from S1 mode to N1 mode, if the UE is a UE operating in single-registration mode in a network supporting N26 interface.

The UE (100) initiates the PDU session release by transmitting a PDU session release request message to the network apparatus (200) to release the PDU session. Upon receiving this request, the network apparatus (200) processes the release and sends a PDU session release procedure message back to the UE (100) to confirm the release of the session. For PDU session modification, the UE (100) transmits a PDU session modification request message to the network apparatus (200) to modify the PDU session. The network apparatus (200) then processes this request and sends a PDU session modification command message to the UE (100) to implement the requested modifications. This interaction ensures that the PDU session is either appropriately released or modified, maintaining the integrity and efficiency of the wireless network system.

If the UE is in the area where the S-NSSAI of the PDU session is not allowed/not supported, then UE (100) should not establish 5GSM procedure but it can initiate:

a) PDU session release procedure to release the PDU session; or

b) PDU session modification procedure to modify the PDU sessions. The UE (100) initiates this procedure when respective trigger to initiate the procedure occurs in the UE.

In an embodiment, a method and system for managing PDU session in the area where it is not allowed/not supported is described. The UE (100) receives an area where the S-NSSAI is allowed or supported and the area where the S-NSSAI is not allowed or not supported in the NAS message from the network apparatus (200). The UE (100) establishes the PDU session of S-NSSAI in the allowed area. The UE (100) moves to the S-NSSAI not allowed/not supported area. The UE (100) is triggered to initiate the 5GSM procedure. Identifying by the UE (100) the 5GSM procedure is of type-1, the UE (100) triggers the procedure based on the identification. Identifying by the UE (100) the 5GSM procedure is of type-2, and the UE (100) barring to trigger the procedure based on the identification, wherein the type-1 procedure is PDU session release procedure or the PDU session modification procedure and the type-2 procedure is PDU session establishment procedure. The term barring in this embodiment implies the UE (100) is forbidden/barred/not allowed to initiate the respective 5GSM procedure.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user equipment (UE) for handling session management (SM) procedures in a wireless network system, the method comprising:
establishing a protocol data unit (PDU) session with a network apparatus in the wireless network system;
determining whether the UE is in a tracking area (TA) where a single-network slice selection assistance information (S-NSSAI) associated with the PDU session is not allowed or not supported by the network apparatus; and
in case that the UE is in the TA where the S-NSSAI of the PDU session is not allowed or not supported by the network apparatus, initiating a PDU session release procedure or initiating a PDU session modification procedure.

2. The method of claim 1, wherein the initiating of the PDU session release procedure comprises:
transmitting a PDU session release request message to the network apparatus; and
receiving a PDU session release procedure message from the network apparatus.

3. The method of claim 1, wherein the initiating of the PDU session modification procedure comprises:
transmitting a PDU session modification request message to the network apparatus; and
receiving a PDU session modification response message from the network apparatus.

4. The method of claim 1, wherein the S-NSSAI is included in a partially allowed NSSAI list of the network apparatus.

5. The method of claim 1, wherein the determining of whether the UE is in the TA where the S-NSSAI associated with the PDU session is not allowed or is not supported by the network apparatus comprises:
detecting that the UE is not in the TA where the S-NSSAI is supported based on at least one of the partially allowed NSSAI list, network slice area of service, location availability information of the S-NSSAI and a time validity window of the S-NSSAI stored at the UE.

6. The method of claim 1, wherein the UE is barred from initiating other fifth generation session management (5GSM) procedures.

7. A method performed by a network apparatus for handling session management (SM) procedures in a wireless network system, the method comprising:
establishing a protocol data unit (PDU) session with a user equipment (UE) in the wireless network system;
receiving one of a PDU session release request message or a PDU session modification request message from the UE, in case that the UE is in a tracking area (TA) where a single-network slice selection assistance information (S-NSSAI) associated with the PDU session is not allowed or not supported by the network apparatus; and
performing one of:
releasing the PDU session associated with the UE when the PDU session release request message is received from the UE, and transmitting a PDU session release response message to the UE after releasing the PDU session, or
modifying the PDU session associated with the UE when the PDU session modification request message is received from the UE, and transmitting a PDU session modification response message to the UE after modifying the PDU session.

8. The method of claim 7, wherein the S-NSSAI is included in a partially allowed NSSAI list of the network apparatus.

9. A user equipment (UE) for handling session management (SM) procedures in a wireless network system, the UE comprising:
a transceiver; and
memory, comprising one or more storage media, storing instructions; and
one or more processors communicatively coupled to the transceiver and the memory,
wherein the instructions, when executed by the one or more processors individually or collectively, cause the UE to:
establish a protocol data unit (PDU) session with a network apparatus in the wireless network system,
determine whether the UE is in a tracking area (TA) where a single-network slice selection assistance information (S-NSSAI) associated with the PDU session is not allowed or not supported by the network apparatus, and
in case that the UE is in the TA where the S-NSSAI of the PDU session is not allowed or not supported by the network apparatus, initiate a PDU session release procedure or initiate a PDU session modification procedure.

10. The UE of claim 9, wherein, to initiate the PDU session release procedure, the instructions, when executed by the one or more processors individually or collectively, cause the UE to:
transmit a PDU session release request message to the network apparatus, and
receive a PDU session release response message from the network apparatus.

11. The UE of claim 9, wherein, to initiate the PDU session modification procedure, the instructions, when executed by the one or more processors individually or collectively, cause the UE to:
transmit a PDU session modification request message to the network apparatus, and
receive a PDU session modification response message from the network apparatus.

12. The UE of claim 9, wherein the S-NSSAI is included in a partially allowed NSSAI list of the network apparatus.

13. The UE of claim 9, wherein, to determine whether the UE is in the TA where the S-NSSAI associated with the PDU session is not allowed or is not supported by the network apparatus, the instructions, when executed by the one or more processors individually or collectively, cause the UE to:
detect that the UE is not in the TA where the S-NSSAI is supported based on at least one of the partially allowed NSSAI list, network slice area of service, location availability information of the S-NSSAI or a time validity window of the S-NSSAI stored at the UE.

14. The UE of claim 9, wherein the UE is barred from initiating other fifth generation session management (5GSM) procedures.

15. A network apparatus for handling session management (SM) procedures in a wireless network system, the network apparatus comprising:
a transceiver; and
memory, comprising one or more storage media, storing instructions; and
one or more processors communicatively coupled to the transceiver and the memory,
wherein the instructions, when executed by the one or more processors individually or collectively, cause the network apparatus to:
establish a protocol data unit (PDU) session with a user equipment (UE) in the wireless network system,
receive one of a PDU session release request message or a PDU session modification request message from the UE, in case that the UE is in a tracking area (TA) where a single-network slice selection assistance information (S-NSSAI) associated with the PDU session is not allowed or not supported by the network apparatus, and
perform one of:
release the PDU session associated with the UE when the PDU session release request message is received from the UE, and transmit a PDU session release response message to the UE after releasing the PDU session, or
modify the PDU session associated with the UE when the PDU session modification request message is received from the UE, and transmit a PDU session modification response message to the UE after modifying the PDU session.

16. The network apparatus of claim 15, wherein the S-NSSAI is included in a partially allowed NSSAI list of the network apparatus.
